(19) United States
(12) Patent Application Publication
(10) Pub. No.: US 2017/0126591 A1
(43) Pub. Date: May 4, 2017

(54) INTELLIGENT VACATION RESPONDER

(71) Applicant: Motorola Mobility LLC, Chicago, IL (US)

(72) Inventors: Raghava Aditya Nukala, Bangalore (IN); Prasanna Kumar Bolisetty Yeswanth Naga, Bangalore (IN)

(21) Appl. No.: 14/930,829

(22) Filed: Nov. 3, 2015

(51) Int. Cl. H04L 12/58; G06Q 10/10

(52) U.S. Cl. CPC H04L 51/02; H04L 51/043; G06Q 10/1093

(57) ABSTRACT

A method, a system, and computer program product for generating and transmitting intelligent autoreply messages in reply to an incoming message. The method includes receiving an incoming message in an inbox of a respondent that has an autoreply message activated and identifying, from content of at least one of the incoming message and the autoreply message, whether at least one pre-established condition is present that triggers an update to the autoreply message prior to transmitting the autoreply message. In response to at least one pre-established condition being present, the autoreply message is autonomously updated to create a modified autoreply message that includes at least one of (i) additional content and (ii) modified content. The type of update that is applied to the autoreply message is based on which pre-established condition is identified.

### BACKGROUND

1. Technical Field

The present disclosure generally relates to autoreply messaging systems and in particular to an improved method for using stored scheduling and contact information to generate and transmit intelligent autoreply messages in reply to an incoming message.

2. Description of the Related Art

In the enterprise environment, use of email and other messaging communication mediums with respondent/user-availability settings and/or options, such as out-of-office/vacation responders and autoreply systems, are ubiquitous. However, traditional autoreply systems do not account for references made by the respondent to other persons in an autoreply message, and in some instances, those other persons may also be out of the office or otherwise unavailable. Additionally, casual or generic references to person(s) by job tasks or other relationships to the respondent (e.g., “my manager” or “contact my team”) are sometimes lost on parties other than the respondent, since those parties may not know to whom the respondent is referring or have no contact information for the person being referred to. Thus, an individual that receives an autoreply message does not receive the benefit of being properly notified of an alternate contact that is available in place of the respondent.

### BRIEF DESCRIPTION OF THE DRAWINGS

FIG. 1 provides a block diagram representation of an example system within which certain aspects of the disclosure can be practiced, in accordance with one or more embodiments;

FIG. 2 illustrates an example analysis component that interfaces with communication received from a sender and a respondent and that generates and transmits modified autoreply messages based on one or more pre-established conditions, in accordance with one or more embodiments;

FIG. 3 is a flow chart illustrating a method for detecting a pre-established condition and delivering a modified autoreply message to a sender of an incoming message based on the pre-established condition, in accordance with one or more embodiments;

FIG. 4A illustrates an example autoreply message and modified autoreply message, in accordance with one or more embodiments;

FIG. 4B is a flow chart illustrating a method for creating a modified autoreply message responsive to a pre-established condition where an autoreply message does not contain contact information for an auxiliary contact, in accordance with one or more embodiments;

FIG. 5A illustrates an example autoreply message and modified autoreply message, in accordance with one or more embodiments;

FIG. 5B is a flow chart illustrating a method for creating a modified autoreply message responsive to a pre-established condition where an autoreply message identifies an auxiliary contact that has a scheduled unavailability identified in at least one scheduling database that is associated with one or more of the auxiliary contact and the respondent, in accordance with one or more embodiments;

FIG. 6A illustrates an example autoreply message and modified autoreply message, in accordance with one or more embodiments;

FIG. 6B is a flow chart illustrating a method for creating a modified autoreply message responsive to a pre-established condition where an autoreply message contains a generalized reference to a colleague of a respondent, in accordance with one or more embodiments;

FIG. 7 is a flow chart illustrating a method for creating a modified autoreply message responsive to a pre-established condition where an incoming message is detected as being associated with a particular task, in accordance with one or more embodiments; and

FIG. 8 is a flow chart illustrating a method for determining at least one currently available party, in accordance with one or more embodiments.

### DETAILED DESCRIPTION

The illustrative embodiments provide a method, a system, and computer program product for generating and transmitting intelligent autoreply messages in reply to an incoming message. The method includes receiving an incoming message in an inbox of a respondent that has an autoreply message activated and identifying, from content of at least one of the incoming message and the autoreply message, whether at least one pre-established condition is present that triggers an update to the autoreply message prior to transmitting the autoreply message. In response to at least one pre-established condition being present, the autoreply message is autonomously updated to create a modified autoreply message that includes at least one of (i) additional content and (ii) modified content. The type of update that is applied to the autoreply message is based on which pre-established condition is identified.

In another embodiment, the at least one pre-established condition comprises the autoreply message including at least one generalized reference to a colleague of the respondent that does not include a name and contact information of the colleague. The name and contact information for the colleague are retrieved from a contact database and the at least one generalized reference to the colleague is replaced with the name and contact information of the colleague. The autoreply message is then transmitted to a sender of the incoming message with the name and contact information of the colleague included within the autoreply message. In one additional embodiment, the at least one generalized reference describes a work position that is associated with the colleague.

In another embodiment, the at least one pre-established condition comprises the incoming message being associated with a particular task that is assigned to the respondent. At least one currently available party that is also assigned to the particular task is then determined and contact information for the at least one currently available party is retrieved from a contact database. A statement is then inserted within the autoreply message that identifies the at least one currently available party along with contact information for the at least one currently available party and the autoreply message is transmitted to the sender with the statement included within the autoreply message.

In another embodiment, the at least one currently available party is determined by accessing a scheduling database associated with the respondent and reading an entry in the scheduling database that is associated with the particular task. Another party within the entry that is also assigned to the particular task is then identified and a scheduling calendar associated with the other party is accessed to determine if the other party has a scheduled unavailability at the present time. In response to determining the other party does not presently have a scheduled unavailability at the present time, the other party is identified as the at least one currently available party.

In another embodiment, the at least one pre-established condition comprises the autoreply message including at least one notification that the sender of the incoming message should contact at least one auxiliary contact. In response to determining the autoreply message does not include contact information for the at least one auxiliary contact, the contact information for the at least one auxiliary contact is retrieved from a contact database. The contact information for the at least one auxiliary contact is then inserted within the autoreply message and the autoreply message is transmitted to the sender with the contact information of the at least one auxiliary contact included within the autoreply message.

In an alternate embodiment a scheduling calendar of the auxiliary contact is checked to determine if the auxiliary contact is available. In response to the scheduling calendar indicating that the auxiliary contact has a scheduled unavailability, at the present time, the autoreply message is modified by removing the at least one notification corresponding to the unavailable auxiliary contact and the modified autoreply message is transmitted to the sender. In another embodiment, the autoreply message is further modified by inserting at least one additional content that identifies when at least one of the respondent and the unavailable auxiliary contact will become available.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description. The above as well as additional objectives, features, and advantages of the present disclosure will become apparent in the following detailed written description.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

As utilized herein, an inbox refers to an incoming message repository associated with a messaging account that is assigned to a person or party for a messaging service. The messaging service may be, for example, but not limited to, an email service, short-messaging service, instant messaging service, or any suitable combination of the foregoing. The person or party assigned to the account receiving the incoming message is referred to as the respondent, and the person or party that generated the incoming message is referred to as the sender.

Those of ordinary skill in the art will appreciate that the hardware components and basic configuration depicted in the following figures may vary. For example, the illustrative components within data processing system 100 are not intended to be exhaustive, but rather are representative to highlight essential components that are utilized to implement the present disclosure. For example, other devices/components may be used in addition to or in place of the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

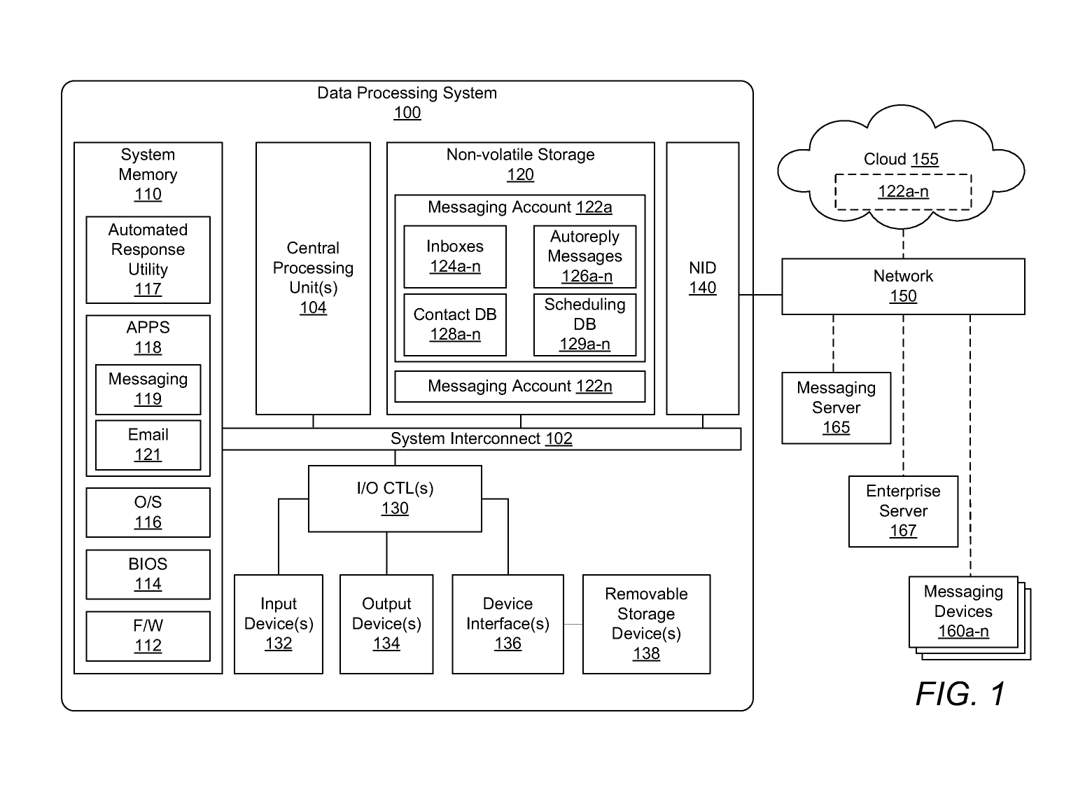

With reference now to the figures, and beginning with FIG. 1, there is depicted a block diagram representation of an example data processing system (DPS) 100, within which one or more of the described features of the various embodiments of the disclosure can be implemented. Data processing system 100 includes at least one central processing unit (CPU) or processor 104 coupled to system memory 110 via system interconnect 102. System interconnect 102 can be interchangeably referred to as a system bus, in one or more embodiments. These one or more software and/or firmware modules can be loaded into system memory 110 during operation of DPS 100. Specifically, in one embodiment, system memory 110 can include therein a plurality of such modules, including one or more of firmware (F/W) 112, basic input/output system (BIOS) 114, operating system (OS) 116, and application(s) 118. In one embodiment, applications 118 may include messaging application 119 and/or an email application 121. These software and/or firmware modules have varying functionality when their corresponding program code is executed by CPU 104 or secondary processing devices within data processing system 100.

Autoreply analysis and response utility (AARU) 117 is a utility that executes within DPS 100 to provide logic that performs the various method and functions described herein. For simplicity, AARU 117 is illustrated and described as a stand-alone or separate software/firmware/logic component, which provides the specific functions and methods described below. However, in at least one embodiment, AARU 117 may be a component of or may be combined with or incorporated within OS 116 and/or one or more of applications 118, such as a messaging application 119 or email application 121. In another embodiment AARU 117 may be a component of a proprietary (enterprise) messaging system or open messaging system. In yet another embodiment AARU 117 may be a component of a device used by the respondent that also contains an inbox associated with the respondent.

In one embodiment DPS 100 may be a server or cloud device that executes AARU 117 for performing the various method and functions described herein. In an alternate embodiment DPS 100 can be a personal device such as a desktop computer, notebook computer, mobile phone, tablet, or any other electronic device that supports local messaging functionality.

Data processing system 100 further includes one or more input/output (I/O) controllers 130, which support connection by and processing of signals from one or more connected input device(s) 132, such as a keyboard, mouse, hardware button(s), touch screen, infrared (IR) sensor, fingerprint scanner, or microphone. I/O controllers 130 also support connection to and forwarding of output signals to one or more connected output devices 134, such as monitors and audio speaker(s). Additionally, in one or more embodiments, one or more device interfaces 136, such as an optical reader, a universal serial bus (USB), a card reader, Personal Computer Memory Card International Association (PCMIA) slot, and/or a high-definition multimedia interface (HDMI), can be associated with DPS 100. Device interface(s) 136 can be utilized to enable data to be read from or stored to corresponding removable storage device(s) 138, such as a compact disk (CD), digital video disk (DVD), flash drive, or flash memory card. In one or more embodiments, device interfaces 136 can further include General Purpose I/O interfaces such as I²C, SMBus, and peripheral component interconnect (PCI) buses.

Data processing system 100 comprises a network interface device (NID) 140. NID 140 enables DPS 100 and/or components within DPS 100 to communicate and/or interface with other devices, services, and components that are located external to DPS 100. These devices, services, and components can interface with DPS 100 via an external network, such as example network 150, using one or more communication protocols. Network 150 can be a local area network, wide area network, personal area network, and the like, and the connection to and/or between network and DPS 100 can be wired or wireless or a combination thereof. Additionally, network 150 may also be further connected to a messaging server 165, enterprise server 167, and/or one or more messaging devices 160a-n which may be used to send or receive messages with DPS 100.

In one embodiment messaging server 165 may also include AARU 117, messaging application 119 and one or more messaging accounts 122a-n that are associated with one or more inboxes 124a-n in order to perform one or more functions and methods described herein. Messaging server may facilitate the transmission or storage of incoming messages or autoreply messages between a sender and a respondent.

In another embodiment enterprise server 167 may also include AARU 117, messaging application 119 and one or more messaging accounts 122a-n. Enterprise 167 may also store and manage inboxes 124a-n, autoreply messages 126a-n, contact databases 128a-n, and scheduling databases 129a-n in order to perform one or more functions and methods described herein. Enterprise server 167 may also facilitate the transmission or storage of incoming messages or autoreply messages between a sender and a respondent. DPS 100, cloud 155, messaging server, 165, messaging devices 160a-n, and/or any other devices (not pictured) connected to enterprise server 167 may deposit, retrieve, access, or modify autoreply messages and/or messages in inboxes stored within the enterprise. Additionally, contact databases and/or scheduling databases stored within enterprise server 167 may be accessed by DPS 100, cloud 155, messaging server, 165, messaging devices 160a-n, and/or any other devices (not pictured) in order to determine a past, current, or future availability, any scheduled unavailability, and/or contact information of any parties represented therein.

DPS 100 may also directly connect to cloud network 155 via NID 140. For purposes of discussion, network 150 is indicated as a single collective component for simplicity. However, it is appreciated that network 150 can comprise one or more direct connections to other devices as well as a more complex set of interconnections as can exist within a wide area network, such as the Internet.

Also coupled to system interconnect bus 102 is nonvolatile storage 120, within which can be stored one or more software and/or firmware modules and one or more sets of data that can be utilized during operations of DPS 100. Messaging accounts 122a-n may also be stored within non-volatile storage 120. Each messaging account is associated with at least one party comprising, for example, but not limited to, users, projects, devices, tasks, devices, clients, departments, and/or companies and/or any combination thereof. Each messaging account 122a-n comprises at least one inbox 124a-n, autoreply messages 126a-n, one or more contact databases 128a-n, and one or more scheduling databases 129a-n. Each messaging account 122 is reachable using one or more identifiers which may comprise, for example, but not limited to, an electronic mail address, a location, a phone number, a unique identifier (UID), device identifier, handle/nickname, account name, and/or account number. In another embodiment, an inbox 124 may be shared by multiple messaging accounts (e.g., a customer service inbox). Messages sent to an identifier are delivered to all associated messaging accounts 122. Additionally, each identifier may be associated with one or more of messaging account 122a-n. An identifier can be associated with, but not limited to, one or more of: users, projects, tasks, devices, clients, departments, and/or companies and/or any combination thereof.

Autoreply messages 126a-n are pre-established messages associated with a messaging account that are automatically sent by DPS 100 in reply to an incoming message from a sender when the autoreply function is set (“on”) within the account. Autoreply messages 126a-n are created by a party associated with a messaging account 126 prior to receiving the incoming message. In another embodiment, autoreply messages 126a-n may also include an autoreply message template that is used to generate autoreply messages on behalf of a respondent and/or one or more non-user created autoreply messages.

Contact databases 128a-n comprise listings of contacts for a messaging account 122a-n. Each listing contains contact information associated with a person/party including, but not limited to, names, phone numbers, electronic mail addresses, mail addresses, account names/numbers, unique identifiers (UIDs), device identifiers, and handle/nicknames.

Scheduling databases 129a-n provide a daily schedule for an associated messaging account and identify when a particular party associated with that messaging account has a scheduled unavailability. Scheduling databases 129a-n may further include a calendar for tracking the particular party and any other parties known to or associated with the particular party. A scheduled availability is a period of time recorded in a scheduling database 129 associated with a messaging account 122 that indicates that a party associated with that messaging account is busy or unavailable. A scheduled unavailability may correspond to time periods where a party is out of the office for any reason, including, but not limited to, a sick time, vacation time, personal holiday time, company holiday time, federal holiday time, and general out of the office time. In another embodiment, a scheduled unavailability may further extend to scheduled events during a time where a party is in or out of the office, such as appointment meetings/appointments, interviews, and conference calls. In still another embodiment, contact databases 128a-n and scheduling databases 129a-n may be combined in a single database.

In the illustrated embodiment, the contact databases 128a-n and scheduling databases 129a-n are illustrated as being associated with a particular user. In another embodiment, one or more of contact databases 128a-n and scheduling databases 129a-n may be shared among multiple parties and/or multiple messaging accounts (e.g., a shared organization contact directory and a shared organization scheduling calendar). In another embodiment, scheduling databases 129a-n may interface with other local or remote scheduling databases in order to facilitate exchanging of schedule information (including one or more instances of scheduled unavailability) for parties associated with messaging account 122a-n or messaging accounts of other systems.

While messaging accounts 122a-n are illustrated within nonvolatile storage 120, messaging accounts 122a-n and/or any inboxes 124a-n, autoreply messages 126a-n, contact databases 128a-n, and scheduling databases 129a-n associated with messaging accounts 122a-n may also be stored in system memory 110, in cloud network 155, and/or in one or more external storage repositories (not pictured) and may be further accessible by DPS 100, cloud network 155, messaging devices 160a-n, and other devices (not pictured) connected thereto. Additionally, any of messaging accounts 122a-n, inboxes 124a-n, autoreply messages 126a-n, contact databases 128a-n, and scheduling databases 129a-n may also be stored on messaging server 165 where they may be accessed by DPS 100, cloud 155, and messaging devices 160a-n.

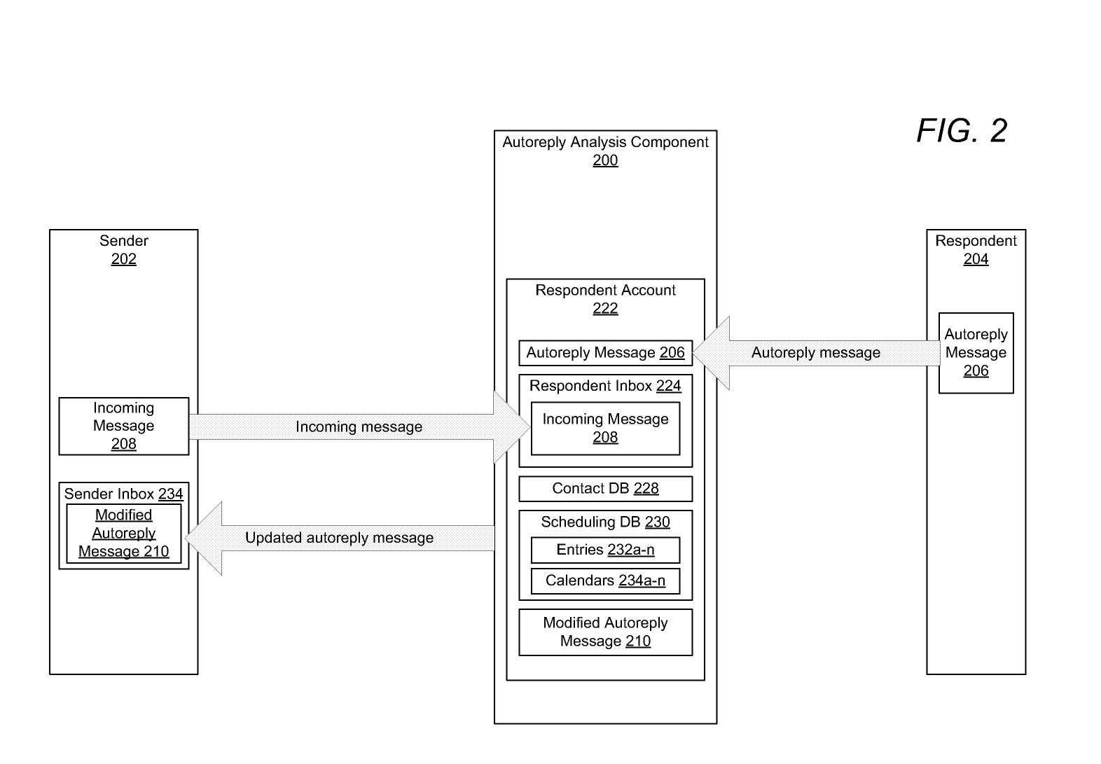

FIG. 2 illustrates an example autoreply analysis component (AAC) 200 that interfaces communications received from a sender 202 and a respondent 204 and that creates/generates and transmits modified autoreply messages based on a pre-established condition, in accordance with one or more embodiments. AAC 200 comprises a processor that executes AARU 117. In another embodiment AAC 200 may be a general purpose data processing system such as DPS 100 or server 165.

AAC 200 is communicatively coupled to (i) a sender 202 that is associated with a sender account (not pictured) and (ii) to a respondent 204. Respondent 204 is associated with respondent account 222 and respondent inbox 224, contact database 228, scheduling database 230, and autoreply message 206. While FIG. 2 illustrates respondent 204 as being separate from AAC 200, in another embodiment AAC 200 may be a component on a same device used by respondent 204. In another embodiment, any of sender 202 and respondent 204 may be utilizing messaging applications and/or utilities operating within a same system. In still another embodiment, AAC 200, sender 202, and respondent 204 may all function within a same cloud-based system.

Contact database 228 comprises one or more contact databases (e.g. Contact DB 128a-n) that store contact information for one or more contacts known to or associated with the respondent 204. Scheduling database 230 comprises schedule and/or calendar information for respondent 204 and one or more contacts known to or associated with the respondent 204. Scheduling database 230 may also further contain entries 232a-n that identify tasks associated with any of respondent 204, sender 202, and any other parties. Tasks may include projects, assignments, responsibilities, missions, work, jobs, errands, etc. Each task may be associated with one or more parties. Scheduling database 230 may also further identify particular responsibilities for each person that is associated with a task.

AC 200 selects an autoreply message 206 associated with respondent 204 responsive to receiving incoming message 208 which is intended for respondent inbox 224. The autoreply message is a message that is intended to be automatically returned to any sender that submits an incoming message to respondent inbox 224. The autoreply message may contain a general electronic message and may also identify one or more auxiliary contacts which are other parties or messaging accounts that the sender should reach while the respondent is unavailable. In one embodiment, auxiliary contacts may be specifically identified within autoreply message 206 by a name or phone number, for example. In another embodiment, auxiliary contacts may be identified by a generalized reference to a colleague of the respondent 204 that does not include a name and contact information of the colleague, such as by a title (e.g. “my manager”).

After the respondent 204 creates autoreply message 206, the autoreply message 206 is saved for future use by AAC 200. While FIG. 2 only illustrates a single autoreply message 206, in another embodiment, respondent 204 may create multiple autoreply messages, each of which may be designated for transmission to a sender in response to a particular criterion being met. Additionally, individual autoreply messages may be designated for particular parties, such as, a first autoreply message for external contacts, a second autoreply message for internal contacts, and a third autoreply message for a particular contact(s).

Sender 202 sends incoming message 208, which is intended for respondent 204, and the incoming message is received by (or forwarded to) AAC 200. After receiving incoming message 208, AAC 200 parses the content of the incoming message and determines from content of incoming message 208 and autoreply message 206 whether at least one pre-established condition is present that triggers an update to autoreply message 206 prior to transmitting autoreply message 206 to sender 202. The content of the incoming message may include any content of the incoming message, including, but not limited to, content in the message body, sender and addressee fields, header information, and date/time of receipt information. In response to at least one pre-established condition being present, autoreply message 206 is autonomously updated by AAC 200 to create modified autoreply message 210, which resolves or addresses the at least one pre-established condition. AAC 200 then delivers modified autoreply message 210 to sender inbox 234. While sender inbox 234 is illustrated in FIG. 2 as being separate from AAC 200, in another embodiment, sender inbox 234 may also be stored within AAC 200. Additionally, a messaging account of sender 202 and sender inbox 234 may be associated with either a same messaging service or a different messaging service as respondent account 222 and respondent inbox 224. For example, a sender account may be an email account hosted by a first email provider, while respondent account 222 is hosted by a second email provider.

Pre-established conditions may be associated with conditions present in one or both of incoming message 208 and autoreply message 206. In one embodiment, a pre-established condition is autoreply message 206 not including contact information for at least one auxiliary contact identified in the autoreply message 206. In response to detecting this condition, AAC 200 retrieves missing contact information associated with the at least one auxiliary contact from contact database 228 and inserts the missing contact information within autoreply message 206 to create modified autoreply message 210. Modified autoreply message 210 is then delivered to sender inbox 234.

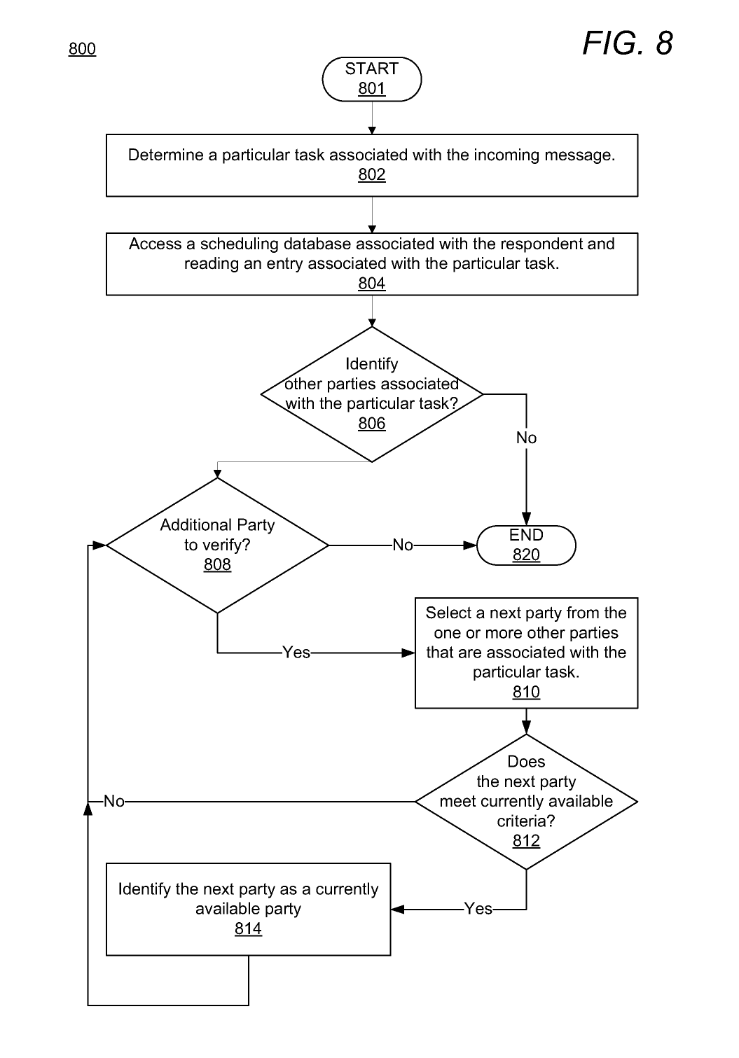

In another embodiment a pre-established condition is autoreply message 206 not identifying any auxiliary contact. In response to detecting this condition, AAC 200 accesses scheduling database 230 and reads calendars/schedules 234a-n of other parties associated with the respondent in order to determine at least one contact that is currently available. The other parties include, for example, any parties assigned to a same task as the respondent, parties in a same organization, department, team, or group as the respondent, parties having an organizational relationship to the respondent (e.g. a manager or assistant of the respondent), and/or parties previously designated as auxiliary contacts by the respondent. Contact information associated with the at least one contact that is currently available is then retrieved from contact database 228 and inserted within autoreply message 206 to create modified autoreply message 210. Modified autoreply message 210 is then delivered to sender inbox 234. The determination of the at least one contact that is currently available is described in greater detail below in method 800 of FIG. 8.

In another embodiment a pre-established condition is autoreply message 206 identifying at least one auxiliary contact that has a scheduled unavailability. In response to detecting this condition, AAC 200 accesses scheduling database 230 to determine at least one alternate contact that is currently available. In response to determining there exists at least one alternate contact that is currently available, contact information associated with the at least one contact that is currently available is retrieved from contact database and used to create modified autoreply message 210 by replacing the identification of the at least one auxiliary contact that has a scheduled unavailability with the contact information associated with the at least one contact that is currently available. In response to determining no other contact exists that is currently available, a modified autoreply message 210 is created by updating the autoreply to (1) remove identification of the at least one auxiliary contact (and any other associated text and/or images) or (2) insert at least one additional content within the autoreply message that identifies when at least one of respondent 204 and the unavailable auxiliary contact will become available. The modified autoreply message 210 is delivered to sender inbox 234. The determination of the at least one contact that is currently available is described in greater detail below in method 800 of FIG. 8.

In another embodiment, a pre-established condition is autoreply message 206 including a generalized reference to a colleague associated with respondent 204 that does not include a name and contact information of the colleague (e.g. “my manager”). In response to detecting this condition, AAC 200 accesses contact database 228 and/or scheduling database 230 and retrieves the name and contact information of the colleague. The name and contact information of the colleague is then inserted within autoreply message 206 to create modified autoreply message 210. Modified autoreply message 210 is then delivered to sender inbox 234. In one embodiment, the name and contact information replaces the generalized reference. In another embodiment, the name and contact information for the colleague is added before or after the generalized reference

In another embodiment, the pre-established condition is incoming message 208 identifying a specific task associated with respondent 204 and the autoreply message not identifying at least one auxiliary contact and/or the at least one auxiliary contact having a scheduled unavailability. In response to detecting this condition, AAC 200 accesses scheduling database 230 to determine one or more other contacts that are currently available and that are also assigned to or capable of performing the specific task within the particular enterprise. In response to determining one or more other contacts exist that are currently available and that are assigned to or capable of performing the specific task, contact information associated with at least one of the one or more other contacts is retrieved from contact database and is inserted within the autoreply message to create modified autoreply message 210. In the embodiments where an unavailable auxiliary contact is included in the original autoreply message, the contact information replaces the at least one auxiliary contact having a scheduled unavailability. Modified autoreply message 210 is then delivered to sender inbox 234. The determination of the at least one contact that is currently available is described in greater detail below in method 800 of FIG. 8.

In another embodiment, AAC 200 may only insert or remove names and/or contact information within the autoreply message for parties that are associated with a same task as respondent 204 or that are directly associated with a same organization, department, team, or group as respondent 204. In yet another embodiment, only auxiliary contacts in an autoreply message that are determined to not be currently available are removed and/or replaced. Thus, some auxiliary contacts in an autoreply message may also be included in the modified autoreply message while other auxiliary contacts in the autoreply message that are determined as not being currently available may be removed or replaced with currently available parties in the modified autoreply message. Additionally, a particular auxiliary contact in an autoreply message that is determined to not be currently available may be replaced with multiple currently available parties in the modified autoreply message. Conversely, multiple auxiliary contacts in an autoreply message that are determined to not be currently available may be replaced with a single currently available party in the modified autoreply message.

In another embodiment, in response to determining the incoming message is marked as important and is addressed to a particular identifier, a short message service message may be sent to at least one phone number of the respondent and any other parties that are associated with the particular identifier.

In yet another embodiment, AAC 200 may monitor the creation and/or drafting of an autoreply message by a respondent and autonomously analyze the autoreply message during creation/drafting to determine an out of the office time period associated with the first party as well as which auxiliary contacts are included within the autoreply message. AAC 200 may then send an alert to the respondent in response to determining (1) that the respondent has not identified an auxiliary contact in the autoreply message or (2) that at least one auxiliary contact identified in the autoreply message is currently unavailable and/or has a scheduled unavailability during a portion of the out of the office time period.

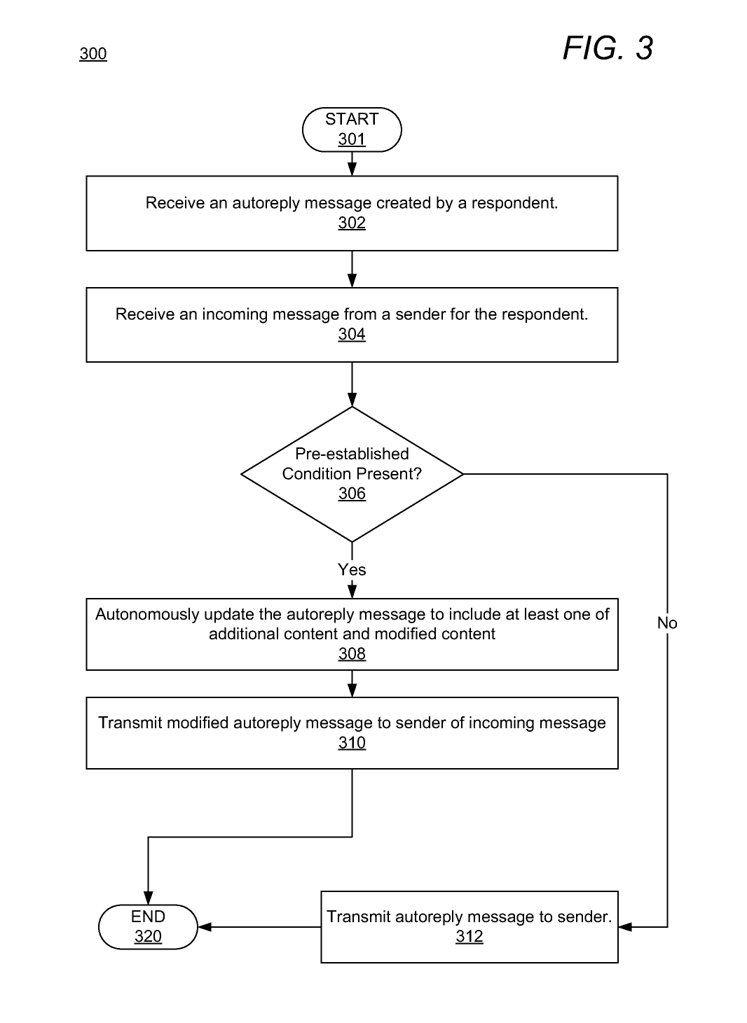

Referring now to FIGS. 3, 4B, 5B-D, 6B, 7, and 8, there are illustrated flow charts of various methods for providing a modified autoreply message to a sender of an incoming message, according to one or more embodiments. Aspects of the methods are described with reference to the components of FIGS. 1-2. Several of the processes of the methods provided in FIGS. 3, 4C, 5C-E, 6C, 7, ad 8 can be implemented by the CPU 104 executing software code of AARU 117 within a data processing system. For simplicity, the methods described below are generally described as being performed by DPS 100.

Referring now to FIG. 3, there is depicted a high-level flow-chart illustrating a method for detecting a pre-established condition and delivering a modified autoreply message to a sender of an incoming message based on the pre-established condition, in accordance with one or more embodiments of the present disclosure. Method 300 commences at initiator block 301, which proceeds to block 302 at which point an autoreply message is received in a messaging account that is associated with a respondent. At block 304 DPS 100 determines where messaging account receives an incoming message intended for the respondent from a sender. In response to receiving the incoming message, DPS 100 analyzes autoreply message and the incoming message to determine if a pre-established condition is present (block 306). In response to determining that a pre-established condition is present, the method continues to block 308 where a modified autoreply message is created by updating the autoreply message to include at least one of an additional content and a modified content. At block 310, the modified autoreply message is delivered to an inbox associated with the sender of the incoming message. The method then ends at block 320. In response to determining that a pre-established condition is not present, Method 300 continues to block 312 where the autoreply message is delivered to the inbox associated with the sender of the incoming message. The method then terminates at block 320.

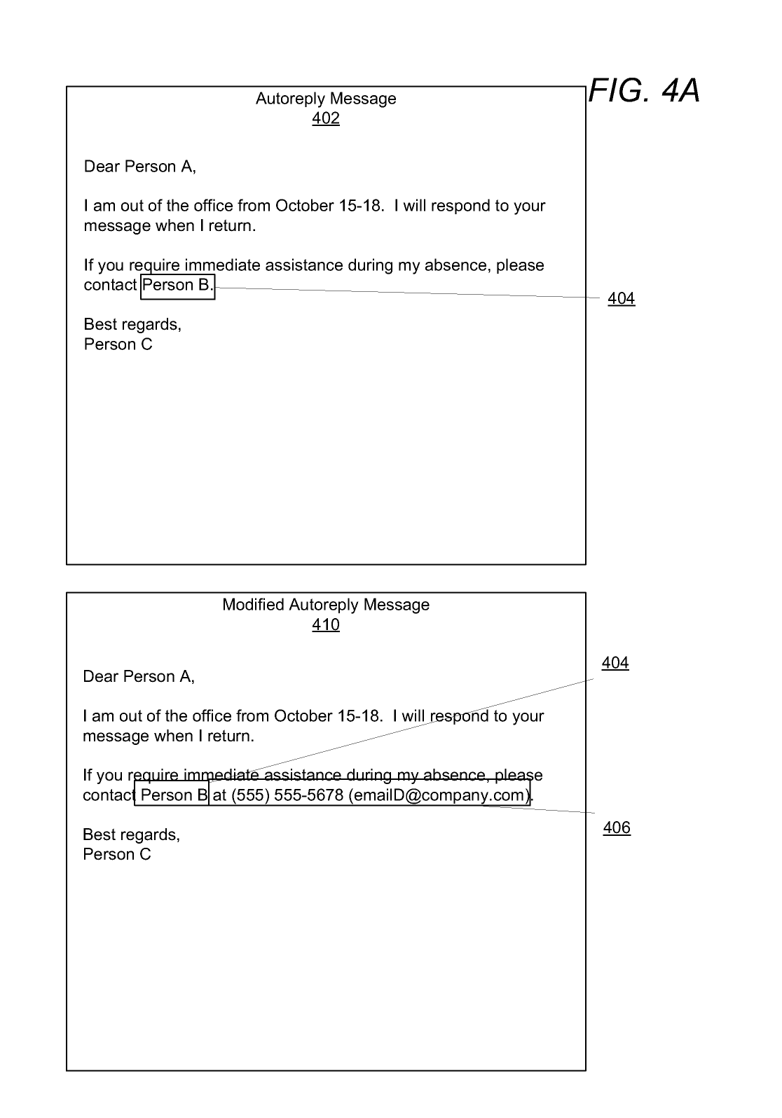

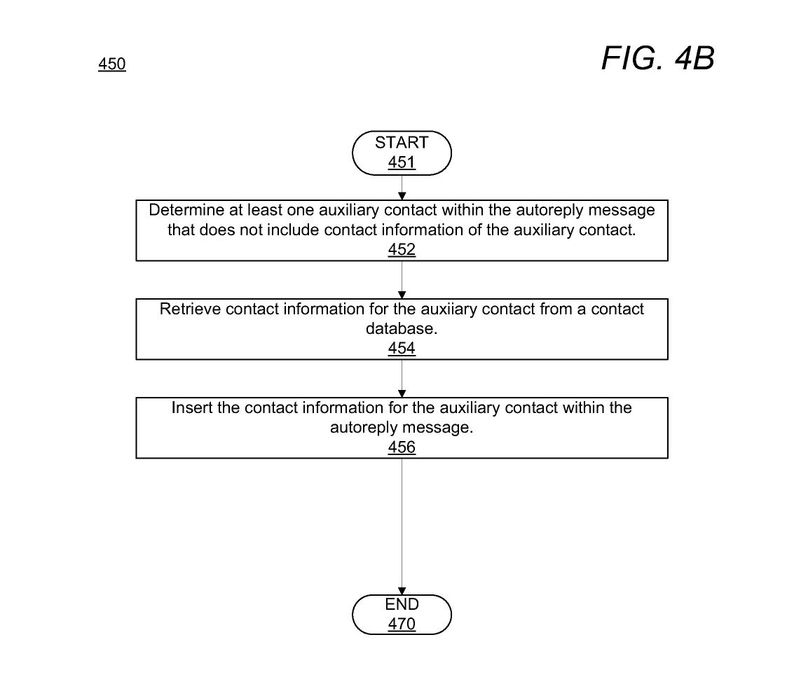

Referring now to FIG. 4A, there is illustrated an example autoreply message and modified autoreply message, in accordance with one or more embodiments of the present disclosure. As shown, autoreply message 402 contains an identification of an auxiliary contact 404, Person B, that does not include contact information for the auxiliary contact. In response to detecting this pre-established condition, DPS 100 creates a modified autoreply message 410 by modifying autoreply message 402 to include contact information 406 associated with Person B. DPS 100 retrieves contact information associated with the at least one auxiliary contact from at least one contact database that is associated with one or more of the auxiliary contact and the respondent. After creating modified autoreply message 410, DPS 100 delivers the modified autoreply message 410 to an inbox associated with the sender of the incoming message.

Referring now to FIG. 4B, there is depicted a high-level flow-chart illustrating a method 450 for creating a modified autoreply message in response to a pre-established condition where an autoreply message does not include contact information for an auxiliary contact, in accordance with one or more embodiments of the present disclosure. Method 450 commences at initiator block 451, which proceeds to block 452 at which point DPS 100 determines at least one auxiliary contact within the autoreply message that does not include contact information. At block 454, DPS 100 retrieves contact information associated with the at least one auxiliary contact from at least one contact database that is associated with one or more of the auxiliary contact and the respondent. At block 456, the retrieved contact information for the at least one auxiliary contact is inserted in the autoreply message to create a modified autoreply message. The method then ends at block 470.

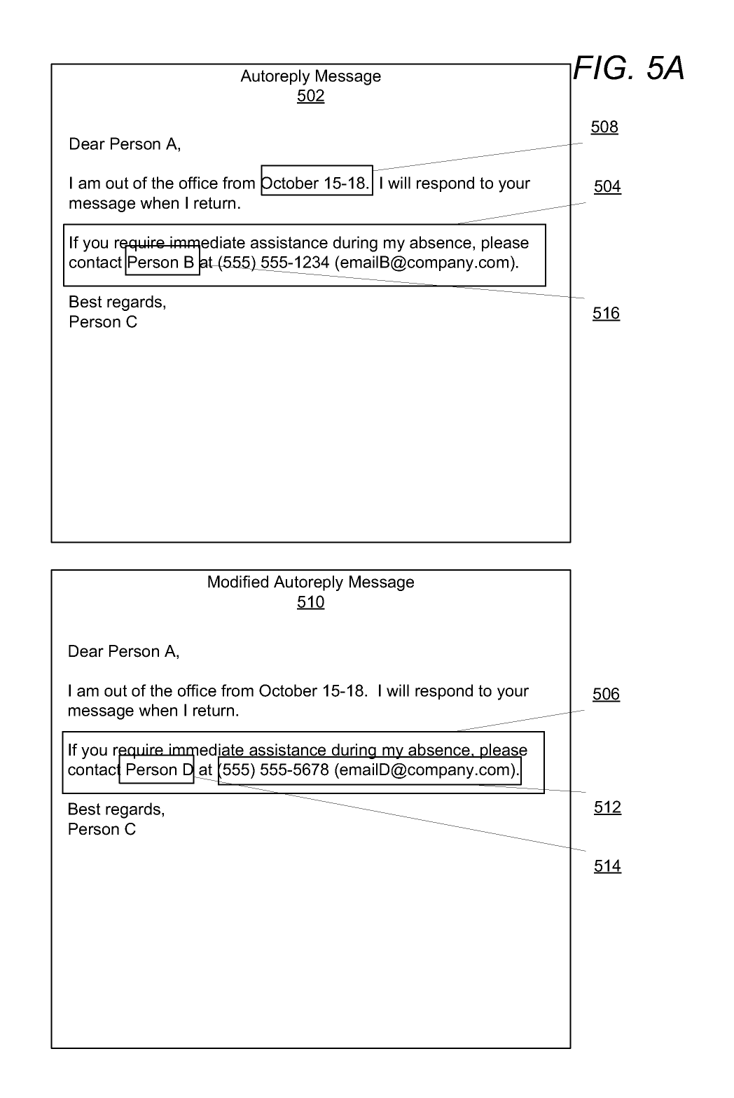

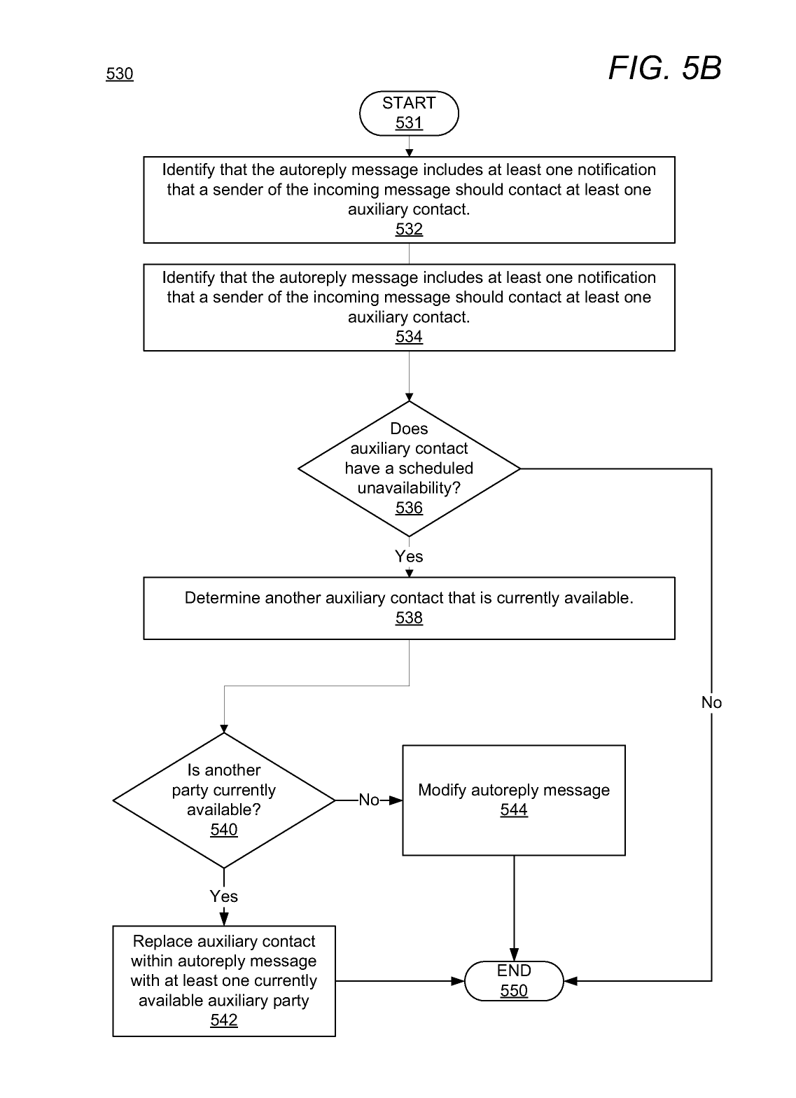

Referring now to FIG. 5A, there is illustrated an example autoreply message and modified autoreply message, in accordance with one or more embodiments of the present disclosure. As shown, autoreply message 502 contains an identification of at least one auxiliary contact 504. At least one scheduling database that is associated with one or more of the auxiliary contact and the respondent is accessed to determine whether the at least one auxiliary contact 504 has a scheduled unavailability at the present time. In an alternate embodiment, the at least one scheduling database is accessed to determine whether the at least one auxiliary contact 504 has a scheduled unavailability at a time during an unavailability period 508 of the respondent that is identified in autoreply message 502. In response to detecting a pre-established condition where the auxiliary contact has a scheduled unavailability, DPS 100 creates a modified autoreply message 510 by modifying autoreply message 502 to include at least one contact that is currently available (currently available party 514) and contact information 512 for the at least one currently available party 514 (block 506). DPS 100 identifies the at least one currently available party 514 by accessing the at least one scheduling database. In one embodiment, the at least one currently available party 514 may also be a party that is also determined to be associated with a same task as the respondent. In yet another embodiment, contact information 512 associated with the at least one currently available party 514 may be retrieved from at least one contact database that is associated with one or more of the auxiliary contact, the at least one currently available party 514, and the respondent. After creating modified autoreply message 510, DPS 100 delivers modified autoreply message 510 to an inbox associated with the sender of the incoming message.

Referring now to FIG. 5B, there is depicted a high-level flow-chart illustrating a method 530 for creating a modified autoreply message where an autoreply message identifies an auxiliary contact that has a scheduled unavailability identified in at least one scheduling database that is associated with one or more of the auxiliary contact and the respondent, in accordance with one or more embodiments of the present disclosure. Method 530 commences at initiator block 531, which proceeds to block 532 at which point DPS 100 identifies the autoreply message as including at least one notification that a sender of the incoming message should contact at least one auxiliary contact. At block 534 at least one scheduling database that is associated with one or more of the auxiliary contact and the respondent is accessed to determine whether the at least one auxiliary contact 504 has a scheduled unavailability at the present time. At block 536 DPS 100 accesses the at least one scheduling database that is associated with one or more of the auxiliary contact and the respondent to determine whether the at least one auxiliary contact has a scheduled unavailability. In response to determining that the at least one auxiliary contact does not have a scheduled unavailability, the method ends (block 550).

In response to determining that the at least one auxiliary contact has a scheduled unavailability, DPS 100 determines, via the at least one scheduling database, whether at least one currently available party exists that can be designated as an auxiliary contact within the autoreply message (block 538). In response to determining that at least one currently available party exists that can be designated as an auxiliary contact within the autoreply message (block 540), the at least one auxiliary contact that has a scheduled unavailability is replaced with the at least one currently available party in order to create a modified autoreply message (block 542). The method then ends at block 550.

In response to determining that no currently available party exists (block 540), the autoreply message is modified to create a modified autoreply message (block 544). In one embodiment the autoreply message is modified by removing the at least one notification corresponding to the at least one auxiliary contact. In another embodiment, the at least one scheduling database is accessed to determine when at least one of the respondent and the unavailable auxiliary contact will become available. The autoreply message is then modified to include an additional statement that identifies when at least one of the respondent and the unavailable auxiliary contact will become available. The method then ends at block 550.

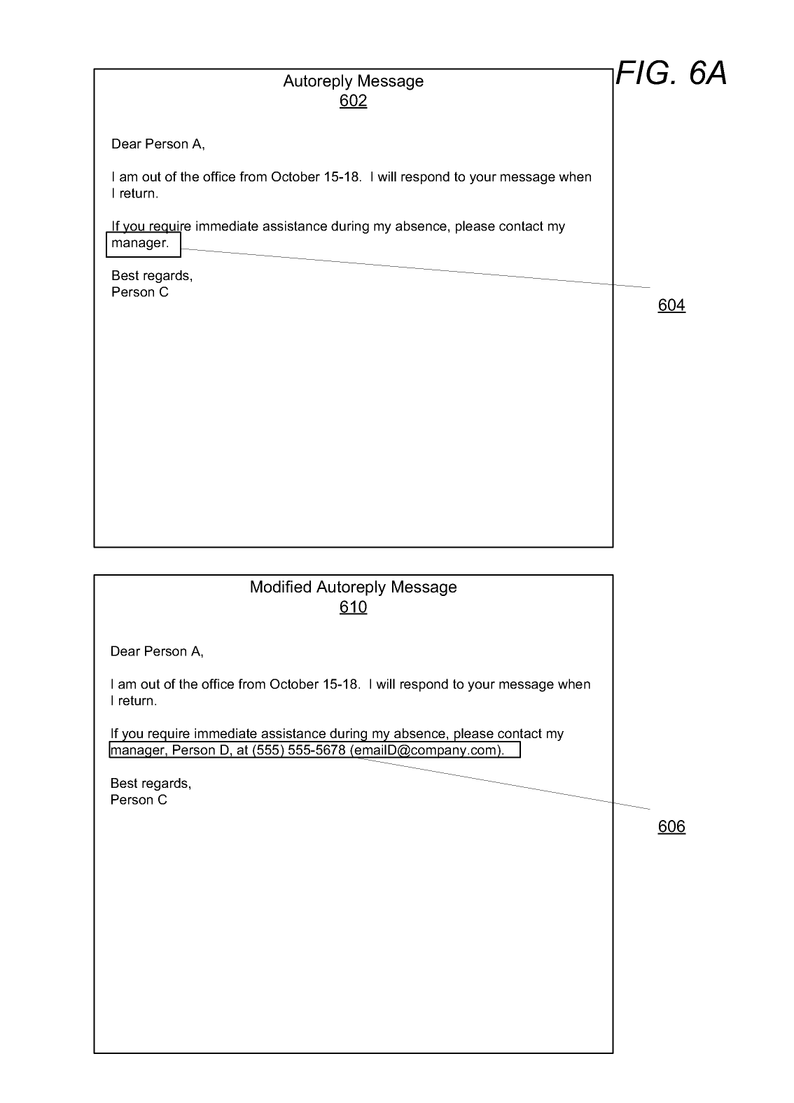

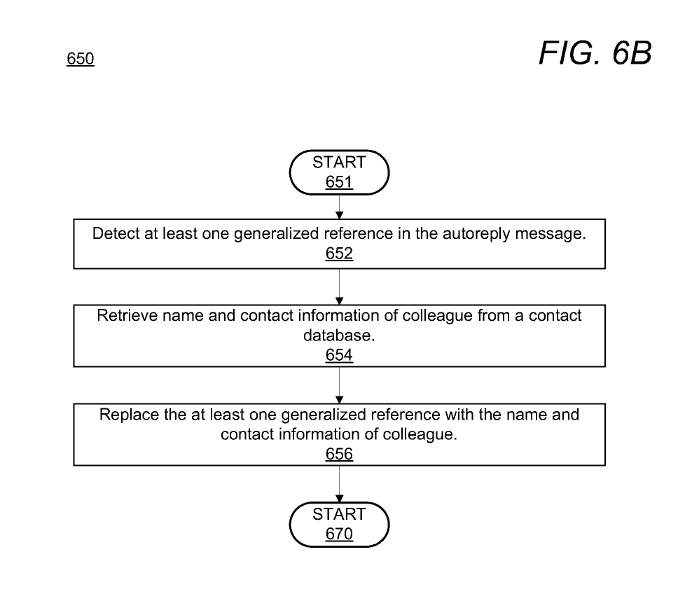

Referring now to FIG. 6A, there is illustrated an example autoreply message and modified autoreply message, in accordance with one or more embodiments of the present disclosure. As shown, autoreply message 602 contains an identification of an auxiliary contact 604, which is generalized reference to a colleague of the respondent, where the generalized reference does not include a name and contact information 606 of the colleague. In response to detecting the generalized reference, DPS 100 retrieves contact information associated with the generalized reference from at least one of a contact database and/or a scheduling database that is associated with one or more of the colleague and the respondent. DPS 100 then creates a modified autoreply message by replacing the at least one generalized reference with the name and contact information 606 of the colleague. After creating the modified autoreply message 610, DPS 100 delivers modified autoreply message 610 to an inbox associated with the sender of the incoming message.

Referring now to FIG. 6B, there is depicted a high-level flow-chart illustrating a method 650 for creating a modified autoreply message responsive to an autoreply message containing a generalized reference to a colleague of a respondent, in accordance with one or more embodiments of the present disclosure. Method 650 commences at initiator block 651, which proceeds to block 652 at which point DPS 100 detects at least one generalized reference to a colleague in the autoreply message. At block 654, DPS 100 retrieves the name and contact information of the colleague from at least one of a contact database and/or a scheduling database. In response to retrieving the name and contact information of colleague, the method continues to block 656 where DPS 100 creates a modified autoreply message by replacing the at least one generalized reference with the name and contact information of colleague. The method then ends at block 670.

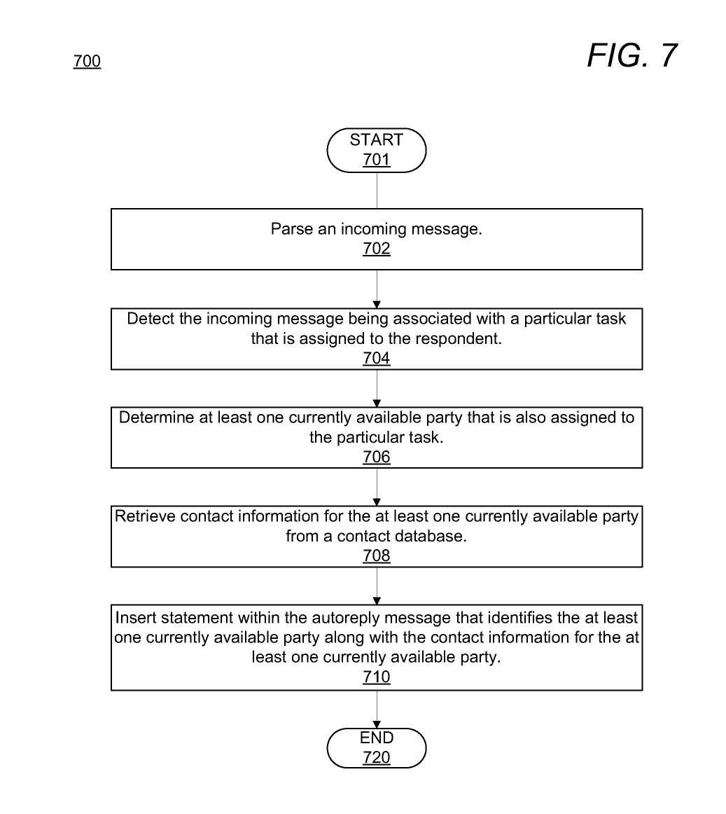

Referring now to FIG. 7, there is depicted a high-level flow-chart illustrating a method 700 for creating a modified autoreply message responsive to a pre-established condition where an incoming message is detected as being associated with a particular task, in accordance with one or more embodiments of the present disclosure. Method 700 commences at initiator block 701, which proceeds to block 702 at which point content of an incoming message is parsed to determine whether the incoming message is associated with a particular task. In response to determining the incoming message is associated with a particular task DPS 100 then determines, at block 704, whether the particular task is associated with one or both of the sender and the respondent. At block 706, DPS 100 accesses at least one scheduling database that is associated with one or more of the sender and the respondent in order to determine at least one currently available party that is also assigned to the particular task. In response to determining the at least one currently available party, DPS 100 accesses at least one contact database that is associated with one or more of the sender and the respondent in order to retrieve contact information for the at least one currently available party that is also assigned to the particular task (block 708). The method continues to block 710 where DPS 100 creates a modified autoreply message by inserting a statement within the autoreply message that identifies the at least one currently available party along with the contact information for the at least one currently available party. The method then ends at block 720.

Referring now to FIG. 8, there is depicted a high-level flow-chart illustrating a method 800 for determining at least one currently available party in accordance with one or more embodiments of the present disclosure. Method 800 commences at initiator block 801, which proceeds to block 802 where DPS 100 determines a particular task that is associated with the incoming message. In one embodiment the particular task is determined by matching an identifying information of a task identified in the incoming message with identifying information of a task in a scheduling database (e.g., matching job identifiers or client identifiers).

In another embodiment, an inbox of the respondent is reachable by one or more identifiers (e.g. an inbox receives messages from projectABC@respondentcompany.com, projectXYZ@respondentcompany.com, and userA@respondentcompany.com). A particular task may be determined based on a particular identifier that the sender used to send the incoming message to the respondent (e.g. the sender addressing the incoming message to projectXYZ@respondentcompany.com). In yet another embodiment, the particular task is determined by matching contact information of the sender from the incoming message to contact information identified in a task of one or more tasks assigned to the respondent in a scheduling database.

In response to identifying the particular task, DPS 100 accesses at least one scheduling database that is associated with one or more of a sender and a respondent of an incoming message and reads an entry associated with the particular task which identifies any other parties (other than the respondent) that are associated with the particular task (block 804). The method then continues to block 806 where DPS 100 identifies whether any other parties are associated with the particular task. In response to determining no other parties are associated with the particular task, the method ends at block 820.

In response to determining there are one or more other parties that are associated with the particular task, the method continues to block 808 where it is determined whether there is at least one additional party from the one or more other parties that needs to be verified as being currently available or currently unavailable. In response to determining that at least one additional party remains to be verified, the method continues to block 810 where a next party that is associated with the particular task is selected. DPS 100 then identifies, from the at least one scheduling database, whether the next party meets a currently available criteria (block 812).

In one embodiment a next party is determined to meet currently available criteria based on that party having no scheduled unavailability at the present time. In another embodiment a next party is determined to meet currently available criteria based on that party having no scheduled unavailability during an out of the office time period of the respondent. This information can be identified in at least one of the autoreply message and the at least one scheduling database. For example, a next party may be determined to not be currently available when the autoreply message indicates the respondent is out October 5-20 and a scheduling database indicates the next party has a scheduled unavailability on October 15 and 17-18. In this example, the next party is not identified as a currently available party because during the out of office time period of the respondent (October 5-20) the next party has a scheduled unavailability (on both October 5 and again between October 17-18). In another embodiment, a next party is determined to be currently available when the scheduling database indicates that the next party is physically at a work location or is otherwise logged into a work computer network.

In response to determining the next party meets the currently available criteria, the method proceeds to block 814 where DPS 100 identifies the next party as a currently available party, and the method then loops back to block 808. In response to determining the next party does not meet the currently available criteria, the method then loops back to block 808. In response to determining that no additional parties remain to be identified as being either currently available or currently unavailable, the process terminates (block 820). Any next parties that are identified as being currently available may then be inserted, as an auxiliary contact(s), into an autoreply messages that do not already identify at least one auxiliary contact. The next parties that are identified as being currently available may also replace any auxiliary contacts in an autoreply message that are determined to have a scheduled unavailability and/or any generalized references in the autoreply message.

In the above described flow charts, one or more of the method processes may be embodied in a computer readable device containing computer readable code such that a series of steps are performed when the computer readable code is executed on a computing device. In some implementations, certain steps of the methods are combined, performed simultaneously or in a different order, or perhaps omitted, without deviating from the scope of the disclosure. Thus, while the method steps are described and illustrated in a particular sequence, use of a specific sequence of steps is not meant to imply any limitations on the disclosure. Changes may be made with regards to the sequence of steps without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object oriented programming language, without limitation. These computer program instructions may be provided to a processor of a general purpose computer, special purpose computer, or other programmable data processing apparatus to produce a machine, such that the instructions, which execute via the processor of the computer or other programmable data processing apparatus, performs the method for implementing the functions/acts specified in the flowchart and/or block diagram block or blocks.

As will be further appreciated, the processes in embodiments of the present disclosure may be implemented using any combination of software, firmware or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples of the computer readable storage device would include the following non-exhaustive list: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible medium that can contain, or store a program for use by or in connection with an instruction execution system, apparatus, or device.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A method comprising:
receiving an incoming message in an inbox of a respondent that has an autoreply message activated;
identifying from content of at least one of the incoming message and the autoreply message whether at least one pre-established condition is present that triggers an update to the autoreply message prior to transmitting the autoreply message; and
in response to at least one pre-established condition being present, autonomously updating the autoreply message to include at least one of additional content and modified content, wherein the update that is applied to the autoreply message is based on which pre-established condition is identified.

2. The method of claim 1, wherein the at least one pre-established condition comprises:
the autoreply message including at least one generalized reference that refers to a colleague of the respondent and that does not include a name and contact information of the colleague, and the method further comprises:
retrieving the name and contact information for the colleague from a contact database;
replacing the at least one generalized reference to the colleague with the name and contact information of the colleague to create a modified autoreply message; and
transmitting the modified autoreply message to a sender of the incoming message with the name and contact information of the colleague included within the modified autoreply message.

3. The method of claim 2, wherein the at least one generalized reference describes a work position that is associated with the colleague.

4. The method of claim 1, wherein the at least one pre-established condition comprises:
the incoming message being associated with a particular task that is assigned to the respondent, and the method further comprises:
determining at least one currently available party that is also assigned to the particular task;
retrieving contact information for the at least one currently available party from a contact database;
inserting a statement within the modified autoreply message that identifies the at least one currently available party along with contact information for the at least one currently available party to create a modified autoreply message; and
transmitting the modified autoreply message to a sender of the incoming message with the statement included within the modified autoreply message.

5. The method of claim 4, wherein determining the at least one currently available party further comprises:
accessing a scheduling database associated with the respondent and reading an entry in the scheduling database that is associated with the particular task;
identifying another party within the entry that is also assigned to the particular task;
accessing a scheduling calendar associated with the other party to determine if the other party has a scheduled unavailability at the present time; and
in response to determining the other party does not presently have a scheduled unavailability at the present time, identifying the other party as the at least one currently available party.

6. The method of claim 1, wherein the at least one pre-established condition comprises:
the autoreply message including at least one notification that a sender of the incoming message should contact at least one auxiliary contact, and the method further comprises:
in response to determining the autoreply message does not include contact information for the at least one auxiliary contact:
retrieving the contact information for the at least one auxiliary contact from a contact database; and
inserting the contact information for the at least one auxiliary contact within the autoreply message to create a modified autoreply message; and
transmitting the modified autoreply message to the sender with the contact information of the at least one auxiliary contact included within the modified autoreply message.

7. The method of claim 1, wherein the at least one pre-established condition further comprises:
the autoreply message including at least one notification that a sender of the incoming message should contact at least one auxiliary contact, and the method further comprises:
checking a scheduling calendar associated with the auxiliary contact to determine if the auxiliary contact is available;
in response to the scheduling calendar indicating that the auxiliary contact has a scheduled unavailability at the present time, modifying the autoreply message by removing the at least one notification corresponding to the unavailable auxiliary contact; and
transmitting the modified autoreply message to the sender.

8. The method of claim 7, further comprising:
modifying the autoreply message by inserting at least one additional content that identifies when at least one of the respondent and the unavailable auxiliary contact will become available.

9. A system comprising:
a transceiver component that receives an incoming message for an inbox of a respondent that has an autoreply message activated;
an autoreply analysis component that:
identifies from content of at least one of the incoming message and the autoreply message whether at least one pre-established condition is present that triggers an update to the autoreply message prior to transmitting the autoreply message; and
in response to at least one pre-established condition being present, autonomously updates the autoreply message to include at least one of additional content and modified content, wherein the update that is applied to the autoreply message is based on which pre-established condition is identified.

10. The system of claim 9, wherein the at least one pre-established condition comprises:
the autoreply message including at least one generalized reference that refers to a colleague of the respondent and that does not include a name and contact information of the colleague, and the autoreply analysis component further:
retrieves the name and contact information for the colleague from a contact database;
replaces the at least one generalized reference to the colleague with the name and contact information of the colleague to create a modified autoreply message; and
transmits the modified autoreply message to a sender of the incoming message with the name and contact information of the colleague included within the modified autoreply message.

11. The system of claim 10, wherein the at least one generalized reference describes a work position that is associated with the colleague.

12. The system of claim 9, wherein the at least one pre-established condition comprises:
the incoming message being associated with a particular task that is associated with the respondent, and the autoreply analysis component further:
determines at least one currently available party that is also associated with the particular task;
retrieves contact information for the at least one currently available party from a contact database;
inserts a statement within the autoreply message that identifies the at least one currently available party along with contact information for the at least one currently available party to create a modified autoreply message; and
transmits the modified autoreply message to a sender of the incoming message with the statement included within the modified autoreply message.

13. The system of claim 12, wherein to determine the at least one currently available party the autoreply analysis component further:
accesses a scheduling database associated with the respondent and reading an entry in the scheduling database that is associated with the particular task;
identifies another party within the entry that is also associated with the particular task;
accesses a scheduling calendar associated with the other party to determine if the other party has a scheduled unavailability at the present time; and
in response to determining the other party does not presently have a scheduled unavailability at the present time, identifies the other party as the at least one currently available party.

14. The system of claim 9, wherein the at least one pre-established condition comprises:
the autoreply message including at least one notification that a sender of the incoming message should contact at least one auxiliary contact, and wherein the autoreply analysis component further:
in response to determining the autoreply message does not include contact information for the at least one auxiliary contact:
retrieves the contact information for the at least one auxiliary contact from a contact database; and
inserts the contact information for the at least one auxiliary contact within the autoreply message to create a modified autoreply message; and
transmits the modified autoreply message to the sender with the contact information of the at least one auxiliary contact included within the modified autoreply message.

15. The system of claim 9, wherein the at least one pre-established condition further comprises:
the autoreply message including at least one notification that a sender of the incoming message should contact at least one auxiliary contact, and the autoreply analysis component further:
checking a scheduling calendar associated with the auxiliary contact to determine if the auxiliary contact is available;
in response to the scheduling calendar indicating that the auxiliary contact has a scheduled unavailability at the present time, modifies the autoreply message by removing the at least one notification corresponding to the unavailable auxiliary contact; and
transmits the modified autoreply message to the sender.

16. The system of claim 15, wherein the autoreply analysis component further:
modifies the autoreply message by inserting at least one additional content that identifies when at least one of the respondent and the unavailable auxiliary contact will become available.

17. A computer program product comprising:
a computer readable storage device; and
program code on the computer readable storage device that when executed within a processor provides the functionality of:
receiving an incoming message in an inbox of a respondent that has an autoreply message activated;
identifying from content of at least one of the incoming message and the autoreply message whether at least one pre-established condition is present that triggers an update to the autoreply message prior to transmitting the autoreply message; and
in response to at least one pre-established condition being present, autonomously updating the autoreply message to include at least one of additional content and modified content, wherein the update that is applied to the autoreply message is based on which pre-established condition is identified.

18. The computer program product of claim 17, wherein the at least one pre-established condition comprises the autoreply message including at least one notification that a sender of the incoming message should contact at least one auxiliary contact, and the program code further comprises code that when executed within the processor provides the functionality of:
in response to determining the autoreply message does not include contact information for the at least one auxiliary contact:
retrieving the contact information for the at least one auxiliary contact from a contact database; and
inserting the contact information for the at least one auxiliary contact within the autoreply message to create a modified autoreply message; and
transmitting the modified autoreply message to the sender with the contact information of the at least one auxiliary contact included within the modified autoreply message.

19. The computer program product of claim 17, wherein the at least one pre-established condition comprises the incoming message being associated with a particular task that is associated with the respondent, and the program code further comprises code that when executed within the processor provides the functionality of:
determining at least one currently available party that is also associated with the particular task;
retrieving contact information for the at least one currently available party from a contact database;
inserting a statement within the autoreply message that identifies the at least one currently available party along with contact information for the at least one currently available party to create a modified autoreply message; and
transmitting the modified autoreply message to a sender of the incoming message with the statement included within the modified autoreply message.

20. The computer program product of claim 17, wherein the at least one pre-established condition further comprises the autoreply message including at least one notification that a sender of the incoming message should contact at least one auxiliary contact, and the program code further comprises code that when executed within the processor provides the functionality of:
checking a scheduling calendar associated with the auxiliary contact to determine if the auxiliary contact is available;
in response to the scheduling calendar indicating that the auxiliary contact has a scheduled unavailability at the present time, modifying the autoreply message by removing the at least one notification corresponding to the unavailable auxiliary contact; and
transmitting the modified autoreply message to the sender.
